(19) United States
(12) Patent Application Publication
(10) Pub. No.: US 2008/0081630 A1
(43) Pub. Date: Apr. 3, 2008

(54) Method And System For Configuring A Frequency Modulation (FM) Antenna To Receive Digital Video Broadcasting Handheld (DVB-H) Signals

(76) Inventor: Ahmadreza Rofougaran, Newport Coast, CA (US)

Correspondence Address: MCANDREWS HELD & MALLOY, LTD, 500 WEST MADISON STREET, SUITE 3400, CHICAGO, IL, 60661, US

(21) Appl. No.: 11/536,659

(22) Filed: Sep. 29, 2006

(51) Int. Cl. H04Q 7/20

(52) U.S. Cl. 455/452.1

(57) ABSTRACT

Aspects of a method and system for configuring a frequency modulation (FM) antenna to receive digital video broadcasting handheld (DVB-H) signals are presented. Aspects of the system may include at least one circuit that enables configuration of a length for an antenna based on a wavelength of selected signals to be received by the antenna. The circuitry may also enable selection of a frequency for the selected signals from a group of frequency bands that include an FM frequency band, and at least one of: a VHF frequency band, a UHF frequency band, and a long band (L-band) frequency band.

### CROSS-REFERENCE TO RELATED APPLICATIONS/INCORPORATION BY REFERENCE

This application makes reference to:
U.S. application Ser. No. 11/176,417, filed on Jul. 7, 2005;
U.S. application Ser. No. ______ (Attorney Docket No. 17783US01), filed on even date herewith;
U.S. application Ser. No. ______ (Attorney Docket No. 17784US01), filed on even date herewith;
U.S. application Ser. No. ______ (Attorney Docket No. 17785US01), filed on even date herewith;
U.S. application Ser. No. ______ (Attorney Docket No. 17786US01), filed on even date herewith;
U.S. application Ser. No. ______ (Attorney Docket No. 17787US01), filed on even date herewith;
U.S. application Ser. No. ______ (Attorney Docket No. 17789US01), filed on even date herewith;
U.S. application Ser. No. ______ (Attorney Docket No. 17790US01), filed on even date herewith;
U.S. application Ser. No. ______ (Attorney Docket No. 17791US01), filed on even date herewith;
U.S. application Ser. No. ______ (Attorney Docket No. 17792US01), filed on even date herewith;
U.S. application Ser. No. ______ (Attorney Docket No. 17916US01), filed on even date herewith;
U.S. application Ser. No. ______ (Attorney Docket No. 17917US01), filed on even date herewith;
U.S. application Ser. No. ______ (Attorney Docket No. 17918US01), filed on even date herewith;
U.S. application Ser. No. ______ (Attorney Docket No. 17919US01), filed on even date herewith;
U.S. application Ser. No. ______ (Attorney Docket No. 17920US01), filed on even date herewith;
U.S. application Ser. No. ______ (Attorney Docket No. 17921US01), filed on even date herewith;
U.S. application Ser. No. ______ (Attorney Docket No. 17922US01), filed on even date herewith;
U.S. application Ser. No. ______ (Attorney Docket No. 17923US01), filed on even date herewith;
U.S. application Ser. No. ______ (Attorney Docket No. 17924US01), filed on even date herewith;
U.S. application Ser. No. ______ (Attorney Docket No. 17925US01), filed on even date herewith;
U.S. application Ser. No. ______ (Attorney Docket No. 17926US01), filed on even date herewith;
U.S. application Ser. No. ______ (Attorney Docket No. 17927US01), filed on even date herewith;
U.S. application Ser. No. ______ (Attorney Docket No. 17928US01), filed on even date herewith;
U.S. application Ser. No. ______ (Attorney Docket No. 17929US01), filed on even date herewith; and
U.S. application Ser. No. ______ (Attorney Docket No. 17930US01), filed on even date herewith.

The above stated applications are hereby incorporated herein by reference in their entirety.

### FIELD OF THE INVENTION

Certain embodiments of the invention relate to wireless communication. More specifically, certain embodiments of the invention relate to a method and system for configuring a frequency modulation (FM) antenna to receive digital video broadcasting handheld (DVB-H) signals.

### BACKGROUND OF THE INVENTION

As portable electronic devices and wireless devices become more popular, an increasing range of mobility applications and services are emerging. There are well established radio broadcast services, utilizing the amplitude modulation (AM) and/or frequency modulation (FM) frequency bands that allow reception of audio information and/or data at an FM receiver. Well established, conventional FM broadcasts may enable transmission and reception of analog radio broadcast services.

In the United States, for example, HD radio may be utilized to enable transmission and reception of digital radio broadcast services. Signals transmitted in HD radio may utilize the FM and/or AM frequency bands. In much of the rest of the world, digital audio broadcasting (DAB) may be utilized to enable transmission and reception of digital radio broadcast services. DAB services may be based on digital video broadcast terrestrial (DVB-T) standards. Signals transmitted in DAB may utilize the very high frequency (VHF), ultra high frequency (UHF), or long band (L-band) frequency bands.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and system for configuring a frequency modulation (FM) antenna to receive digital video broadcasting handheld (DVB-H) signals, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary mobile terminal that receives digital multimedia broadcast signals, and HD radio broadcast signals, in accordance with an embodiment of the invention.

FIG. 2A is a block diagram of an exemplary system for configuring an antenna to receive FM signals, in accordance with an embodiment of the invention.

FIG. 2B is a block diagram of an exemplary FM receiver, which may be utilized in connection with an embodiment of the invention.

FIG. 2C is a block diagram of an exemplary system for configuring an antenna to receive DVB-H signals, in accordance with an embodiment of the invention.

FIG. 2D is a high-level block diagram of exemplary DVB-H receiver circuitry in a mobile terminal, which may be utilized in connection with an embodiment of the invention.

FIG. 2E is a block diagram illustrating an exemplary n-array capacitor block that may be utilized for dynamically tuning an antenna, in accordance with an embodiment of the invention.

FIG. 3 is a flow chart illustrating exemplary steps for configuring an antenna to receive FM signals or DVB-H signals, in accordance with an embodiment of the invention.

### DETAILED DESCRIPTION OF THE INVENTION

Certain embodiments of the invention may be found in a method and system for configuring a frequency modulation (FM) antenna to receive digital video broadcasting handheld (DVB-H) signals. Aspects of the system may comprise dynamically configuring a length for an antenna based on the wavelength of selected RF signals to be received via the antenna. The antenna may be configured to a length to receive a selected RF signal whose frequency is within the FM frequency band, or within at least one DVB frequency band. The DVB frequency bands may comprise the VHF, UHF, and L-band frequency bands. The antenna may be configured to its full length for receiving RF signals in the FM frequency band, for example. The antenna may be dynamically reconfigured to about half of its full length for receiving RF signals in the VHF frequency band, for example.

An exemplary FM frequency band utilized in most of the world may comprise a range of frequencies from about 87.5 MHz to about 108 MHz. An exemplary VHF frequency band may comprise a range of frequencies from about 174 MHz to about 230 MHz. An exemplary UHF frequency band may comprise a range of frequencies from about 470 MHz to about 830 MHz. An exemplary L-band frequency band may comprise frequencies from about 1.452 GHz to about 1.492 GHz.

Various embodiments of the invention may enable an antenna in a mobile terminal to be dynamically configured to enable reception of HD radio broadcast signals, and/or to enable reception of DAB signals.

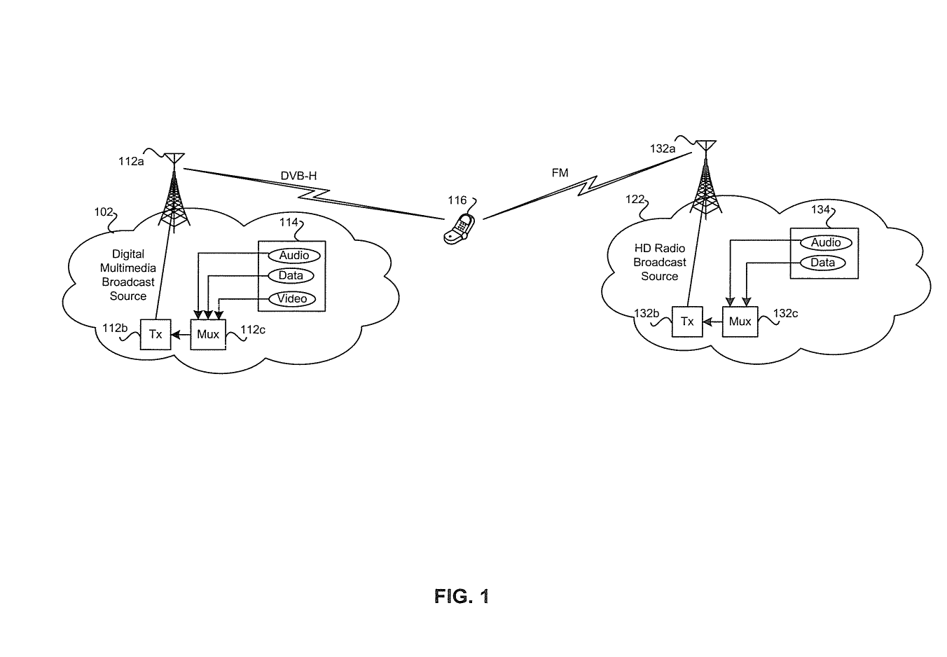

FIG. 1 is a block diagram of an exemplary mobile terminal that receives digital multimedia broadcast signals, and HD radio broadcast signals, in accordance with an embodiment of the invention. Referring to FIG. 1, there is shown a digital multimedia broadcast source 102, an HD radio broadcast source 122, and a mobile terminal (MT) 116. The digital multimedia broadcast source 102 may comprise transmitter (TX) 112b, multiplexer (MUX) 112c, and information content source 114. The content source 114 may comprise audio, data and video content. The digital multimedia broadcast source 102 may also comprise a VHF, UHF, and/or L-band broadcast antennas 112a. The HD radio broadcast source 122 may comprise transmitter (TX) 132b, multiplexer (MUX) 132c, and information content source 134. The content source 134 may comprise audio, and data content. The HD radio broadcast source 122 may also comprise an FM broadcast antenna 132a.

The digital multimedia broadcast source 102 may comprise suitable equipment that may enable DVB-H transmission, which may comprise encoding, encryption and/or multiplexing of visual information, audio information, and/or data for transmission via the transmitter 112a. DVB-H may enable transmission of video entertainment, such as television. DVB-H may enable the transmission of supplemental information, such as program guides. DVB-H may also enable data services such as IP datacasting. The digital multimedia source 102 may also enable DAB transmission, which may comprise encoding, encryption and/or multiplexing of audio information and/or data for transmission via the transmitter 112a. DAB may enable transmission of music and other forms of audio entertainment. In addition, DAB may enable transmission of supplemental information based on radio data system (RDS) specifications, for example. DAB may also enable transmission of data services.

The transmitter 112a within the digital multimedia broadcast source 102 may be adapted to utilize VHF, UHF, and/or L-band broadcast channels to communicate information to the mobile terminal 116. The multiplexer 112b associated with the digital multimedia broadcast source 102 may be utilized to multiplex data from a plurality of sources. For example, the multiplexer 112b may enable multiplexing of various types of information such as audio, video and/or data into a single information stream for transmission by the transmitter 112a.

The HD radio broadcast source 122 may comprise suitable equipment that may enable digital radio transmission, which may comprise encoding, encryption and/or multiplexing of audio information, and/or data for transmission via the transmitter 132a. HD radio may enable transmission of music and other forms of audio entertainment in digital form. In addition, HD radio may enable transmission of supplemental information based on radio broadcast data system (RBDS) specifications, for example. HD radio may also enable transmission of data, for example, comprising text information.

The transmitter 132a within the HD radio broadcast source 122 may be adapted to utilize FM broadcast channels to communicate information to the mobile terminal 116. The multiplexer 132b associated with the HD radio broadcast source 122 may be utilized to multiplex data from a plurality of sources. For example, the multiplexer 132b may enable multiplexing of various types of information such as audio, and/or data into a single information stream for transmission by the transmitter 132a.

The mobile terminal 116 may comprise suitable logic, circuitry, and/or code that may enable DVB-H signal reception, which may comprise decoding, decryption, and/or demultiplexing of visual information, audio information, and/or data for output via a video monitor, and/or audio speaker. The mobile terminal 116 may comprise an antenna that enables reception of VHF, UHF, and/or L-band broadcast channels to receive DVB-H signals. The visual information, audio information, and/or data may be stored and/or processed at the mobile terminal 116. For example, data may comprise downloaded news reports, ring tones, web pages, and/or control information. The mobile terminal 116 may perform MPEG processing of received visual information and/or audio information, for example. Similarly, the mobile terminal 116 may enable DAB reception, which may comprise decoding, decryption, and/or demultiplexing of audio information and/or data for output via the video monitor and/or audio speaker. The mobile terminal 116 may utilize RDS information, for example program information (PI) to identify a digital multimedia broadcast source 102, or an alternative frequency (AF) list to select a frequency for receiving audio information, or traffic announcement (TA) information to display information about traffic conditions within a given proximity.

The mobile terminal 116 may also comprise suitable logic, circuitry, and/or code that may enable reception of FM broadcast channels via an antenna. The reception of FM broadcast channels may enable the reception of HD radio, for example, which may comprise decoding, decryption, and/or demultiplexing of audio information, and/or data for output via a video monitor, and/or audio speaker. The audio information, and/or data may be stored and/or processed at the mobile terminal 116. For example, data may comprise downloaded news reports, ring tones, text information, and/or control information. The mobile terminal 116 may perform MPEG processing of received visual information and/or audio information, for example. The mobile terminal 116 may utilize RBDS information, for example program information (PI) to identify an HD radio broadcast source 122, or an alternative frequency (AF) list to select a frequency for receiving audio information, or traffic announcement (TA) information to display information about traffic conditions within a given proximity.

In various embodiments of the invention, the mobile terminal 116 may configure an antenna to receive VHF, UHF, and/or L-band broadcast channels. The antenna may also be configured for receiving FM broadcast channels.

In addition to the above disclosures, various embodiments of the invention may also be practiced in similar conceivable broadcast systems, such as terrestrial integrated services digital broadcasting (ISDB-T).

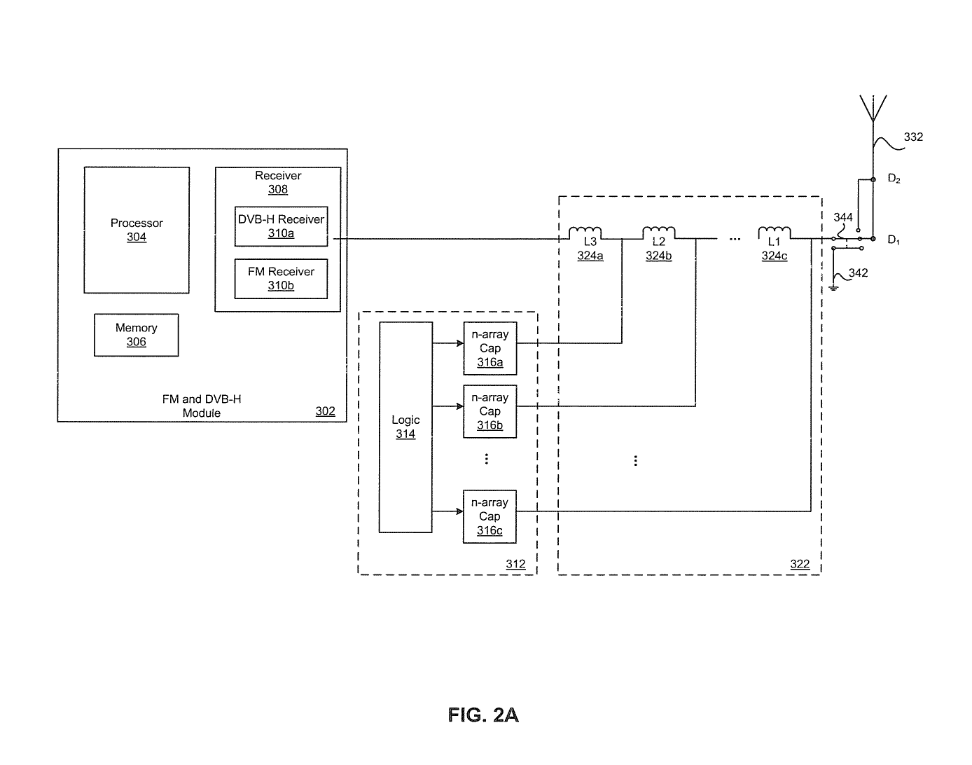

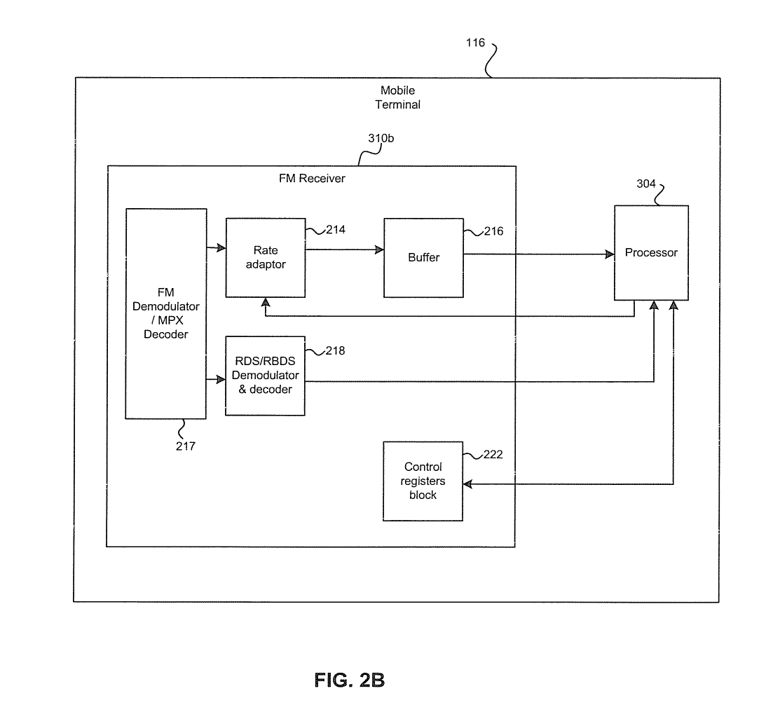

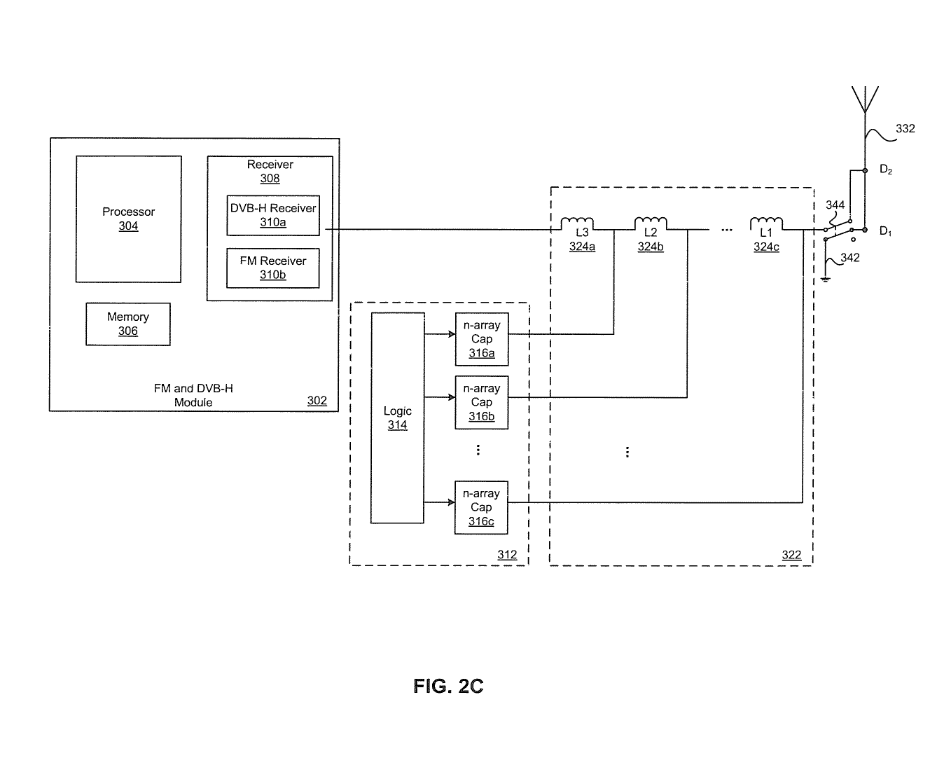

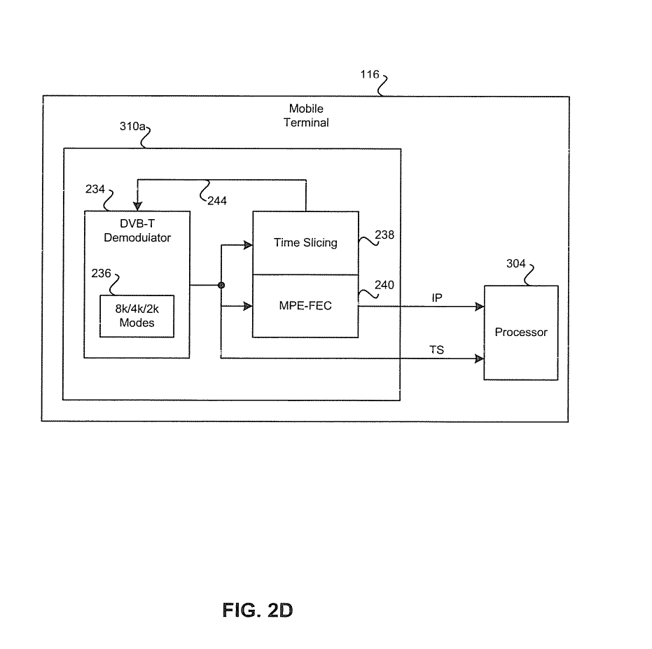

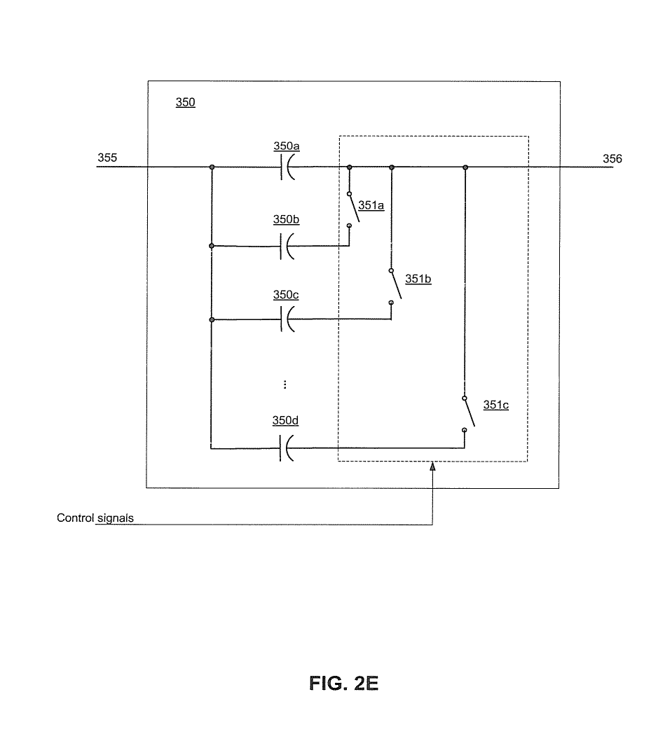

FIG. 2A is a block diagram of an exemplary system for configuring an antenna to receive FM signals, in accordance with an embodiment of the invention. Referring to FIG. 2A, there is shown an FM and DVB-H module 302, a tuning control block 312, an inductive circuit block 322, a ground reference (GND) 342, a switch 344, and an antenna 332. The FM and DVB-H module 302 may comprise a processor 304, a memory 306, and a receiver 308. The tuning control block 312 may comprise a control block 314, and a plurality of capacitor arrays 316a, 316b, . . . , and 316c. A full length antenna 332 may be represented by the reference point labeled D₁. A half length antenna 332 may be represented by the reference point labeled D₂. The mobile terminal 116 is an exemplary system that may comprise an antenna that may be configured to receive FM signals.

The capacitor arrays 316a, 316b, . . . , and 316c may each comprise a plurality of capacitive elements whose capacitances may be added to effectively form different capacitors with different capacitances.

The processor 304 may generate control signals that enable a mobile terminal 116 to receive DVB-H signals. The processor 304 may execute code that enables processing of received data, for example, visual information, audio information, and/or data to produce a multimedia stream that may be output to a video monitor, speaker, and/or other output device.

The processor 304 may generate control signals that enable a communication device, such as a SmartPhone 204, to receive FM signals. The processor 304 may execute code that enables processing of received data, for example processing digital data transmitted in an FM radio station broadcast to produce an audio signal that may output to a speaker and/or processing supplemental program data related to the audio signal.

The memory 306 may comprise suitable logic, circuitry, and/or code that may be utilized to store, or write, and/or retrieve, or read, information, data, and/or executable code. The memory 306 may enable storage and/or retrieval of data that may be utilized for reception of DVB-H signals, and/or FM signals. This data may comprise program information, or preset station selections for reception of DVB-H television broadcasts, DVB-H radio and/or FM radio station broadcasts, for example. The memory 306 may comprise a plurality of random access memory (RAM) technologies such as, for example, DRAM, and/or nonvolatile memory, for example electrically erasable programmable read only memory (EEPROM).

The receiver 308 may enable selection of a frequency at which signals may be received. For example, the receiver 308 may select a frequency within the range 87.5 MHz to 108 MHz when receiving an FM signal, or a frequency that within the range of 174 MHz to 230 MHz when receiving a VHF signal.

The control block 314 may comprise suitable logic, circuitry, and/or code that may enable control of capacitance that may be associated with each of the capacitor arrays 316a, 316b, . . . , and 316c. The inductive elements 324a, 324b, . . . , and 324c may be connected in a series configuration. Each of the capacitor arrays 316a, 316b, . . . , and 316c may be coupled to a node in the inductive circuit block 322. For example, the capacitor array 316a may be coupled to the node between the inductors 324a and 324b, the capacitor array 316b may be coupled to a node between the inductors 324b and 324c, and the capacitor array 316c may be coupled to a node between the inductor 324c and the switch 344.

In operation, the processor 304 may configure the system as shown in FIG. 2A to receive an FM signal. The processor 304 may generate a control signal that causes the switch 344 to couple the antenna 332 reference point D₁, and the inductor 324c. In this regard, the antenna 332 reference point D₂, and GND 342, may be uncoupled, and may therefore be ignored. Based on the coupling to the reference point D₁, the full length of the antenna 332 may be utilized for receiving signals. The full length of the antenna 332 may be about equal to ½ of a wavelength for an FM signal. The processor 304 may retrieve data from the memory 306 that enables selection of a frequency within the FM frequency range. The processor 304 may generate control signals that enable the receiver 308 to receive an FM signal at the selected frequency. The processor 304 may generate control signals that enable the tuning control block 312 to generate a modified version of the selected frequency, which may be utilized to receive an FM signal at the modified version of the selected frequency. The control block 314 may select a capacitance for each of the capacitive arrays 316a, 316b, . . . , and 316c by enabling individual capacitive elements to be used for receiving RF signals from the mobile terminal antenna 332. Accordingly, the impedance of the circuit may be varied, and accordingly, the center frequency and/or the bandwidth associated with the mobile terminal antenna 332 may be adjusted.

FIG. 2B is a block diagram of an exemplary FM receiver, which may be utilized in connection with an embodiment of the invention. Referring to FIG. 2B, there is shown a mobile terminal 116. The mobile terminal 116 may comprise a processor 304 and an FM receiver 310b. The FM receiver 310b may comprise an FM/MPX demodulator and decoder 217, a rate adaptor 214, a buffer 216, an RDS/RBDS demodulator and decoder 218, and a control registers block 222.

The FM/MPX demodulator and decoder 217 may comprise suitable logic, circuitry, and/or code that may enable processing of FM and/or FM MPX stereo audio, for example. The FM/MPX demodulator and decoder 217 may demodulate and/or decode audio signals that may be transferred to the rate adaptor 214. The FM/MPX demodulator and decoder 217 may demodulate and/or decode signals that may be transferred to the RDS/RBDS demodulator and decoder 218. The rate adaptor 214 may comprise suitable logic, circuitry, and/or code that may enable controlling the rate of the FM data received from the FM/MPX demodulator and decoder 217. The rate adaptor 214 may adapt the output sampling rate of the audio data. An initial rough estimate of the adaptation fractional change may be made and the estimate may then refined by monitoring the ratio of reading and writing rates and/or by monitoring the level of the audio samples in the buffer 216. The rate may be adjusted in a feedback manner such that the level of the output buffer is maintained. The rate adaptor 214 may receive a strobe or pull signal from the processor 304, for example. Audio FM data from the rate adaptor 214 may be transferred to the buffer 216. The U.S. application Ser. No. 11/176,417 filed on Jul. 7, 2005, discloses a method and system comprising a rate adaptor, and is hereby incorporated herein by reference in its entirety.

The buffer 216 may comprise suitable logic, circuitry, and/or code that may enable storage of digital audio data. The buffer 216 may receive a strobe or pull signal from the processor 304, for example. The buffer 216 may transfer digital audio data to the processor 304. The RDS/RBDS demodulator and decoder 218 may comprise suitable logic, circuitry, and/or code that may enable processing of RDS/RBDS data from the FM/MPX demodulator and decoder 217. The RDS/RBDS demodulator and decoder 218 may provide further demodulation and/or decoding to data received from the FM/MPX demodulator and decoder 217. The output of the RDS/RBDS demodulator and decoder 218 may be transferred to the processor 304. The control registers block 222 may comprise suitable logic, circuitry, and/or code that may enable the storage of register information that may be utilized to control and/or configure the operation of at least portions of the FM receiver 310b.

FIG. 2C is a block diagram of an exemplary system for configuring an antenna to receive DVB-H signals, in accordance with an embodiment of the invention. FIG. 2B shows the antenna 332, from FIG. 2A, when configured for receiving DVB-H signals. Referring to FIG. 2C, there is shown an FM and DVB-H module 302, a tuning control block 312, an inductive circuit block 322, a ground reference (GND) 342, a switch 344, and an antenna 332. The FM and DVB-H module 302 may comprise a processor 304, a memory 306, and a receiver 308. The receiver 308 may comprise a DVB-H receiver 310a, and an FM receiver 310b. The tuning control block 312 may comprise a control block 314, and a plurality of capacitor arrays 316a, 316b, . . . , and 316c.

In operation, the processor 304 may configure the system as shown in FIG. 2C to receive a DVB-H signal. The processor 304 may generate a control signal that causes the switch 344 to couple the antenna 332 reference point D₂, and the inductor 324c. The switch 344 may also couple the antenna 332 reference point D₁, and GND 342. Based on the couplings to the reference points D₁ and D₂, half of the length of the antenna 332 may be utilized for receiving signals. The half length of the antenna 332 may be about equal to ½ of a wavelength for a VHF signal. The processor 304 may retrieve data from the memory 306 that enables selection of a frequency within the VHF frequency range. The processor 304 may generate control signals that enable the receiver 308 to receive a VHF signal at the selected frequency. The processor 304 may generate control signals that enable the tuning control block 312 to generate a modified version of the selected frequency, which may be utilized to receive a VHF signal at the modified version of the selected frequency. The control block 314 may select a capacitance for each of the capacitive arrays 316a, 316b, . . . , and 316c by enabling individual capacitive elements to be used for receiving RF signals from the mobile terminal antenna 332. Accordingly, the impedance of the circuit may be varied, and accordingly, the center frequency and/or the bandwidth associated with the mobile terminal antenna 332 may be adjusted.

FIG. 2D is a high-level block diagram of exemplary DVB-H receiver circuitry in a mobile terminal, which may be utilized in connection with an embodiment of the invention. Referring to FIG. 2D, there is shown a mobile terminal 230. The mobile terminal 230 may comprise a DVB-H receiver 310a and processor 304. The DVB-H receiver 310a may comprise a DVB-T demodulator 234, time slicing block 238, and MPE-FEC block 240.

The DVB-T demodulator 234 may comprise suitable circuitry, logic and/or code that may be adapted to demodulate a DVB signal. In this regard, the DVB-T demodulator 234 may be adapted to downconvert a received DVB signal to a suitable bit rate that may be handled by the mobile terminal 230. The DVB-T demodulator 234 may be adapted to handle 2 k, 4 k and/or 8 k modes.

The time slicing block 238 may comprise suitable circuitry, logic and/or code that may be adapted to minimize power consumption in the mobile terminal 230, particularly in the DVB-T demodulator 234. In general, time slicing reduces average power consumption in the mobile terminal 230 by sending data in bursts via much higher instantaneous bit rates. In order to inform the DVB-T demodulator 234 when a next burst is going to be sent, a delta indicating the start of the next burst is transmitted within a current burst. During transmission, no data for an elementary stream (ES) is transmitted so as to allow other elementary streams to optimally share the bandwidth. Since the DVB-T demodulator 234 knows when the next burst will be received, the DVB-T demodulator 234 may enter a power saving mode between bursts in order to consume less power. Reference 244 indicates a control mechanism that handles the DVB-T demodulator 234 power via the time slicing block 238. The DVB-T demodulator 234 may also be adapted to utilize time slicing to monitor different transport streams from different channels. For example, the DVB-T demodulator 234 may utilize time slicing to monitor neighboring channels between bursts to optimize handover.

The MPE-FEC block 240 may comprise suitable circuitry, logic and/or code that may be adapted to provide error correction during decoding. On the encoding side, MPE-FEC encoding provides improved carrier to noise ratio (C/N), improved Doppler performance, and improved tolerance to interference resulting from impulse noise. During decoding, the MPE-FEC block 240 may be adapted to determine parity information from previously MPE-FEC encoded datagrams. As a result, during decoding, the MPE-FEC block 240 may generate datagrams that are error-free even in instances when received channel conditions are poor. The processor 304 may comprise suitable circuitry, logic and/or code that may be adapted to process IP datagrams generated from an output of the MPE-FEC block 240. The processor 304 may also be adapted to process transport stream packets from the DVB-T demodulator 234.

In operation, the DVB-T demodulator 234 may be adapted to receive an input DVB RF signal, demodulate the received input DVB RF signal so as to generate data at a much lower bit rate. In this regard, the DVB-T demodulator 234 recovers MPEG-2 transport stream (TS) packets from the input DVB-T RF signal. The MPE-FEC block 240 may then correct any error that may be located in the data and the resulting IP datagrams may be sent to the processor 304 for processing. Transport stream packets from the DVB-T demodulator 234 may also be communicated to the processor 304 for processing.

FIG. 2E is a block diagram illustrating an exemplary n-array capacitor block that may be utilized for dynamically tuning an antenna, in accordance with an embodiment of the invention. Referring to FIG. 2E, there is shown the capacitive array 350, which may be similar to the capacitive arrays 316b, 316b, . . . , and 316c. The capacitive array 350 may comprise the capacitive elements 350a, 350b, 350c, . . . , and 350d, the switches 351a, 351b, . . . , and 351c, and the output nodes 355 and 356.

The control block 314 may control whether each of the switches 351a, 351b, . . . , and 351c may be open or closed via the control signals to the capacitive array 350. If a switch is open, the corresponding capacitive element 350b, 350c, . . . , 350d, respectively, may not be part of a circuit that receives the RF signals from the antenna 332, or part of the circuit that receives and/or transmits NFC and/or RFID signals. Conversely, if a switch is closed, the corresponding capacitive element may be part of the circuit that receives the RF signals, as well as being part of the circuit that receives and/or transmits NFC and/or RFID signals. Accordingly, the impedance of the circuit that receives the RF signals may be adjusted by opening or closing the switches 351a, 351b, . . . , and 351c. Similarly, the impedance of the circuit that receives NFC and/or RFID signals may be adjusted by opening or closing the switches 351a, 351b, . . . , and 351c. Adjusting the impedance in this manner may adjust the center frequency and/or the bandwidth of the antenna 332.

The control block 314 may receive communication, for example, from the processor 304 regarding the center frequency drift for the antenna 332. The communication from the processor 304 may comprise, for example, detailed information regarding switch positions for each capacitive array 316a, 316b, . . . , and 316c. Accordingly, the control block 314 may only need nominal processing to open or close the various switches 351a, 351b, . . . , 351c in the capacitive arrays 316a, 316b, . . . , and 316c. Other embodiments of the invention may communicate signal integrity indicators, for example, received signal strength indication and/or bit error rate, to the control block 314. The control block 314 may then process the signal integrity indicators to determine the center frequency drift, and proper adjustments that may be needed to compensate for the drift. The control block 314 may then open or close the various switches 351a, 351b, . . . , 351c in the capacitive arrays 316a, 316b, . . . , and 316c to adjust the center frequency and/or the bandwidth. Still other embodiments of the invention may allocate processing between the processor 304 and the control block 314. For example, the processor 304 may determine the amount of shift in the center frequency, while the control block 314 may determine a specific configuration for the capacitive arrays 316a, 316b, . . . , and 316c based on the amount of frequency compensation needed.

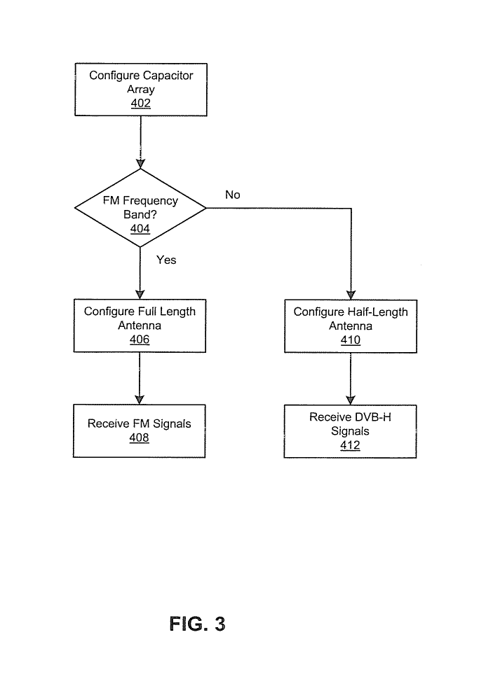

FIG. 3 is a flow chart illustrating exemplary steps for configuring an antenna to receive FM signals or DVB-H signals, in accordance with an embodiment of the invention. Referring to FIG. 3, in step 402, the processor 304 may generate control signals that cause the control block 314 to configure each of the capacitive arrays 316a, 316b, . . . , and 316c. In step 404, the processor 304 may determine a frequency band that may be utilized for receiving and/or transmitting signals. When the FM frequency band is selected in step 404, in step 406, the processor 304 may configure a full length antenna 332 to receive FM signals. When the FM frequency band is not selected in step 404, in step 408, the processor 304 may configure a half length antenna 332 to receive DVB-H signals.

Aspects of a system for configuring an antenna to receive FM signals and DVB-H signals may include a processor 304 that enables configuration of a length for an antenna 332 based on a wavelength of selected signals to be received by the antenna 332. The configuration may enable reception of FM signals, VHF signals, UHF signals, and/or L-band signals. The processor 304 may also enable selection of a frequency for the selected signals from a group of frequency bands that include an FM frequency band, and at least one of: a VHF frequency band, a UHF frequency band, and a long band (L-band) frequency band. The processor 304 may enable coupling of the reference point D₁ of the antenna 332 to at least one inductor 324c when the selected frequency is selected from the FM frequency band. The processor 304 may enable coupling of the reference point D₂ of the antenna 332 to at least one inductor 324c, and coupling of the reference point D₁ of the antenna 332 to the GND 342, when the selected frequency is selected from the VHF frequency band, the UHF frequency band, and/or the L-band frequency band.

The length for the antenna 332, for receiving the selected signals when the selected frequency is selected from the FM frequency band, is about twice the length for the antenna 332, for receiving the selected signals when the selected signal is selected from the VHF frequency band, the UHF frequency band, and/or the L-band frequency band. The processor 304 may enable a mobile terminal 116 to receive HD radio signals via the FM frequency band, and digital audio broadcast (DAB) signals via the VHF frequency band, the UHF frequency band, and/or L-band frequency band. The tuning control block 312 may enable configuration of at least one capacitor array 316a, 316b, . . . , and 316c to modify the selected frequency for receiving the selected signals via the antenna 332.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communicating information in a wireless communication system, the method comprising:
configuring a length for an antenna based on a wavelength of selected signals to be received via said antenna; and
selecting a frequency associated with said selected signals from a group of frequency bands comprising an FM frequency band, and at least one of: a VHF frequency band, a UHF frequency band, and a long band (L-band) frequency band.

2. The method according to claim 1, comprising configuring said antenna and at least one inductor when said selected frequency is selected from said FM frequency band.

3. The method according to claim 1, comprising configuring said antenna and at least one inductor, and said antenna and a ground reference when said selected frequency is selected from said at least one of: said VHF frequency band, said UHF frequency band, an said L-band frequency band.

4. The method according to claim 1, wherein said length for said antenna, for receiving said selected signals when said selected frequency is selected from said FM frequency band, is about twice said length of said antenna, for receiving said selected signals when said selected frequency is selected from said at least one of: said VHF frequency band, said UHF frequency band, and said L-band frequency band.

5. The method according to claim 1, comprising determining a frequency of said selected signals to be received.

6. The method according to claim 5, comprising configuring said antenna length based on said determined frequency of said selected signals to be received.

7. The method according to claim 1, comprising selectively receiving HD radio signals via said FM frequency band, and at least one of: digital video broadcasting handheld (DVB-H) signals and digital audio broadcast (DAB) signals via said at least one of: said VHF frequency band, said UHF frequency band, and said L-band frequency band.

8. The method according to claim 1, comprising configuring at least one capacitor array to modify said selected frequency for receiving said selected signals via said antenna.

9. A system for communicating information in a wireless communication system, the system comprising:
at least one circuit that enables configuration of a length for an antenna based on a wavelength of selected signals to be received via said antenna; and
said at least one circuit enables selection of a frequency associated with said selected signals from a group of frequency bands comprising an FM frequency band, and at least one of: a VHF frequency band, a UHF frequency band, and a long band (L-band) frequency band.

10. The system according to claim 9, wherein said at least one circuit enables configuration of said antenna and at least one inductor when said selected frequency is selected from said FM frequency band.

11. The system according to claim 9, wherein said at least one circuit enables configuration of said antenna and at least one inductor, and said antenna and a ground reference when said selected frequency is selected from said at least one of: said VHF frequency band, said UHF frequency band, an said L-band frequency band.

12. The system according to claim 9, wherein said length for said antenna, for receiving said selected signals when said selected frequency is selected from said FM frequency band, is about twice said length for said antenna, for receiving said selected signals when said selected frequency is selected from said at least one of: said VHF frequency band, said UHF frequency band, and said L-band frequency band.

13. The system according to claim 9, wherein said at least one circuit enables determination of a frequency of said selected signals to be received.

14. The system according to claim 13, wherein said at least one circuit enables configuration of said antenna length based on said determined frequency of said selected signals to be received.

15. The system according to claim 9, wherein said at least one circuit enables selective reception of HD radio signals via said FM frequency band, and at least one of: digital video broadcasting handheld (DVB-H) signals and digital audio broadcast (DAB) signals via said at least one of: said VHF frequency band, said UHF frequency band, and said L-band frequency band.

16. The system according to claim 9, wherein said at least one circuit enables configuration of at least one capacitor array to modify said selected frequency for receiving said selected signals via said antenna.

17. A machine-readable storage having stored thereon, a computer program having at least one code section for communicating information in a wireless communication system, the at least one code section being executable by a machine for causing the machine to perform steps comprising:
configuring a length for an antenna based on a wavelength of selected signals to be received via said antenna; and
selecting a frequency associated with said selected signals from a group of frequency bands comprising an FM frequency band, and at least one of: a VHF frequency band, a UHF frequency band, and a long band (L-band) frequency band.

18. The machine-readable storage according to claim 17, wherein said at least one code section comprises code for configuring said antenna and at least one inductor when said selected frequency is selected from said FM frequency band.

19. The machine-readable storage according to claim 17, wherein said at least one code section comprises code for configuring said antenna and at least one inductor, and said antenna and a ground reference when said selected frequency is selected from said at least one of: said VHF frequency band, said UHF frequency band, an said L-band frequency band.

20. The machine-readable storage according to claim 17, wherein said length for said antenna, for receiving said selected signals when said selected frequency is selected from said FM frequency band, is about twice said length of said antenna, for receiving said selected signals when said selected frequency is selected from said at least one of: said VHF frequency band, said UHF frequency band, and said L-band frequency band.

21. The machine-readable storage according to claim 17, wherein said at least one code section comprises code for selectively receiving HD radio signals via said FM frequency band, and digital audio broadcast (DAB) signals via said at least one of: said VHF frequency band, said UHF frequency band, and said L-band frequency band.

22. The machine-readable storage according to claim 17, wherein said at least one code section comprises code for configuring at least one capacitor array to modify said selected frequency for receiving said selected signals via said antenna.

23. The machine-readable storage according to claim 17, wherein said at least one code section comprises code for determining a frequency of said selected signals to be received.

24. The machine-readable storage according to claim 23, wherein said at least one code section comprises code for configuring said antenna length based on said determined frequency of said selected signals to be received.

25. A system for communicating information in a wireless communication system, the system comprising: at least one circuit that enables configuration of a length for an antenna for reception of FM signals, and at least one of VHF signals, UHF, signals, and long band (L-band) signals.

26. The system according to claim 25, wherein said at least one circuit enables selective reception of HD radio signals via said FM signals, and digital audio broadcast (DAB) signals via said at least one of VHF signals, UHF signals, and L-band signals.
